(19) United States
(12) Patent Application Publication
(10) Pub. No.: US 2011/0044370 A1
(43) Pub. Date: Feb. 24, 2011

(54) Barbecue Tongs With Temperature Sensor

(75) Inventors: Yisroel Ovadyah Schochet, Los Angeles, CA (US); Shmuel Dovid Newman, Redondo Beach, CA (US)

Correspondence Address: Brooks Kushman P.C. / LA, 1000 Town Center, 22nd Floor, Southfield, MI, 48075, US

(73) Assignee: YSN Imports, Inc., Gardena, CA (US)

(21) Appl. No.: 12/839,343

(22) Filed: Jul. 19, 2010

Related U.S. Application Data
(60) Provisional application No. 61/234,670, filed on Aug. 18, 2009.

(51) Int. Cl. A47J 43/28; G01K 13/00; G01K 1/02

(52) U.S. Cl. 374/155; 294/99.2; 294/3; 374/E13.001; 374/E01.002

(57) ABSTRACT

A pair of cooking tongs is provided for use in manipulating and handling food items and displaying the temperature and degree of “doneness” of a meat during cooking. The invention comprises a pair of arms, one of which includes a fork at its end in which there is a temperature sensor. The other arm features a display which is in electronic communication with the temperature sensor. Some embodiments include a speaker which provides an audio signal indicating that the temperature of the meat has reached or passed a selected threshold. The invention allows a user to manipulate food using one hand while conveniently reading the temperature of any of a variety of meats to ensure they are cooked to a desired “doneness,” such as rare, medium rare, medium, and well done.

### RELATED APPLICATIONS

This application claims the benefit of U.S. Provisional Application No. 61/234,670 filed Aug. 18, 2009, the content of which is incorporated by this reference in its entirety for all purposes as if fully set forth herein.

### TECHNICAL FIELD

The present invention relates generally to the field of cooking tongs for use while barbecuing and the like. More particularly, the invention concerns cooking tongs which allow the user to handle food while also measuring the temperature and the doneness of meat.

### BACKGROUND OF THE INVENTION

The use of tongs to handle and manipulate food has been known in the art for a long time. For example, U.S. Pat. Nos. 2,864,645 and 3,356,405 describe tongs with various shapes at the distal ends of the tong arms for handling and gripping food items. Using tongs in conjunction with a barbecue or grill has also been known in the art, as shown, for example, by U.S. Pat. No. 5,934,731. The use of temperature sensors has also been incorporated with barbecue tools in the more recent art. For example, U.S. Pat. No. 5,634,719 describes a food handling device with a boom-mounted temperature probe. U.S. Pat. No. 5,983,783 describes a chefs fork with a temperature sensor that displays the temperature and level of doneness for a selected food type. It also details the requisite operational circuitry for the sensor and display. The current art lacks a suitable invention that can accomplish all of these tasks in an easy-to-use, one-handed device that is also ergonomically friendly. U.S. Design Pat. No. D447,430 illustrates a pair of meat thermometer tongs that have a display on the same side of the tongs as the tines portion, apparently making it very difficult to view the display while the tines are inserted into the meat.

### SUMMARY OF THE INVENTION

The shortcomings of the prior art are overcome and additional advantages are provided by the provision of cooking tongs with a fork, a spatula and a temperature sensor, wherein the temperature readout is conveniently viewable to a user while the fork is inserted in the food item being measured. The cooking tongs generally comprise a first arm, a second arm, a user output portion, a user input portion and operational circuitry.

The first arm has a first inner portion, a first outer portion, a first proximal end, a first distal end and a fork at its first distal end. The fork has at least one tine with a temperature sensor. The second arm has a second inner portion, a second outer portion, a second proximal end and a second distal end. The second arm has a spatula at its second distal end, and is in hinged association with the first arm at generally the second proximal end and the first proximal end.

The user output portion is configured to provide status information to the user, including a temperature of a meat and a doneness of the meat. The user output portion generally includes an electronic display configured to display the temperature and doneness of the meat. The electronic display is disposed on the second outer portion at a distance from the second distal end, thereby allowing the electronic display to be readily viewable to a user while the fork is at least partially inserted in a food item on a cooking surface with the second arm generally disposed above the first arm.

The user input portion is electrically connected to the operational circuitry, and is generally configured to allow the user to readily choose a meat setting from a plurality of meat options and a doneness setting from a plurality of doneness options. The operational circuitry is generally configured to receive input data from the temperature sensor and user input portion, generate output data associated with the status information and send the output data to the user output portion. The user output portion may further include a speaker element electrically connected to the operational circuitry to audibly indicate that the temperature corresponding to the selected level of doneness has been reached.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a perspective view of an embodiment of cooking tongs showing the second arm generally disposed above the first arm;

FIG. 2 is a further perspective view of the embodiment of FIG. 1;

FIG. 3 is an exploded view of the embodiment of FIG. 1;

FIG. 4 is a top view of the embodiment of FIG. 1;

FIG. 5 is a cross-sectional view taken along line 5-5 of FIG. 4;

FIG. 6 is a magnified view of detail 6 in FIG. 4; and

FIG. 7 is a perspective view of an embodiment in use by a user with the fork being at least partially inserted in a food item on a cooking surface with the second arm being generally disposed above the first arm.

### DETAILED DESCRIPTION OF THE PREFERRED EMBODIMENT(S)

Referring now to the drawings, like reference numerals designate identical or corresponding features throughout the several views.

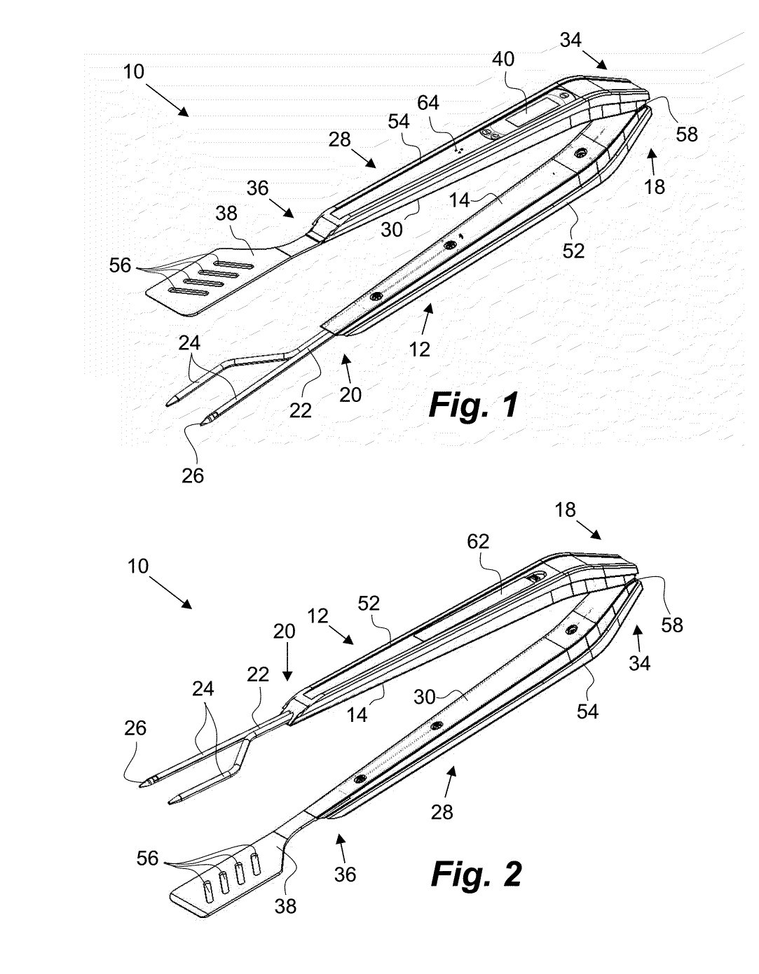

Throughout the several figures, an embodiment of cooking tongs is shown generally at 10. Referring in particular to FIGS. 1-3 for illustration, cooking tongs 10 comprises a first arm 12, a second arm 28, a user output portion and operational circuitry. The first arm 12 has a first inner portion 14, a first outer portion 16, a first proximal end 18 and a first distal end 20. The first arm 12 further has a fork 22 at the first distal end 20. The fork 22 has at least one tine 24, the at least one tine 24 having a temperature sensor 26 therein. The fork 22 of some embodiments may have additional tines 24 with or without temperature sensors, and may be affixed to the first arm with the help of, for example, a bracket 78. The second arm 28 has a second inner portion 30, a second outer portion 32, a second proximal end 34 and a second distal end 36. The second arm 28 further has a spatula 38 at the second distal end 36.

The second arm 28 is in hinged association with the first arm 12 at generally the second proximal end 34 and the first proximal end 18. The hinged association may be achieved by way of a hinge clip 58 elastically clamping the first inner portion 14 to the second inner portion 30 (see, for example, FIG. 5). During operation as tongs, the first arm 12 and second arm 28 can be squeezed together such that a food item is supported between the fork 22 and the spatula 38. The food item can then be moved, flipped, or otherwise manually manipulated by the user. The first arm 12 and second arm 28 are generally biased to return to an open configuration (shown, for example, in FIGS. 1 and 2) when the user is no longer squeezing them together.

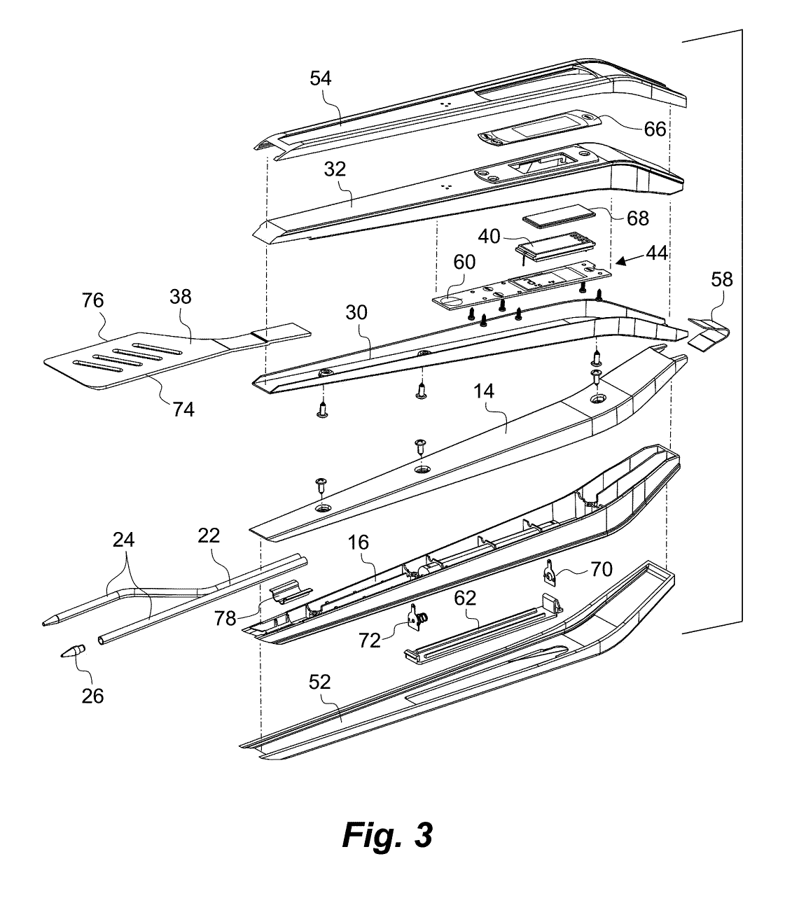

Referring to FIG. 3, in order to protect the user's hand during operation, certain embodiments further comprise a first heat-resistant grip 52 disposed on the first outer portion 16 and a second heat-resistant grip 54 disposed on the second outer portion 32. The heat-resistant grips can be made of any suitable material, such as a rubber or other polymer.

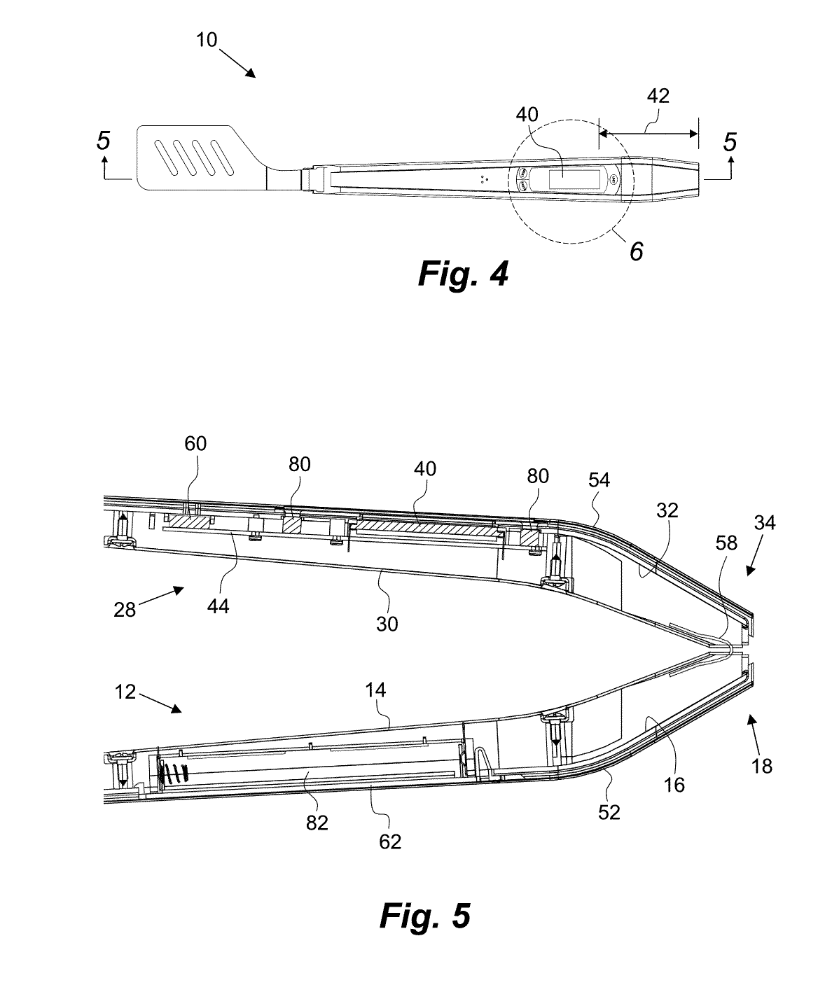

Referring to FIG. 3, the user output portion is configured to provide status information to the user, including a temperature of a meat and a doneness of the meat. The user output portion includes an electronic display 40 configured to display at least the temperature of the meat. Information on the electronic display 40 may be readable through, for example, a display window 68 and interface panel 66. The electronic display 40 is disposed on the second outer portion 32 at a distance from the second distal end 34 (an example of such a distance is shown at 42 in FIG. 4). The distance 42 may be, for example, approximately 2 inches or greater. As illustrated in FIG. 7, this arrangement allows the electronic display 40 to be readily viewable to a user 46 while the fork 22 is at least partially inserted in a food item 48 on a cooking surface 50 with the second arm 28 generally disposed above the first arm 12.

The operational circuitry 44 is in electrical communication with the electronic display 40 and the temperature sensor 26, and may be housed within, for example, the first arm 12 or the second arm 28. At its fundamental level, the operational circuitry 44 is generally known in the art, and an example of such circuitry is described by U.S. Pat. No. 5,983,783, which is incorporated by reference as if fully set forth herein. The operational circuitry 44 is programmed with temperature ranges corresponding to multiple doneness options for various meat options. The doneness options can include well done, medium well, medium, medium rare and rare. Examples of the different meats that may be represented in the operational circuitry 44 and on the electronic display 40 are beef, lamb, pork, chicken, and turkey, as well as any other suitable cooking meat. The operation circuitry 44 is configured to receive input data from the temperature sensor 26, generate output data associated with the status information, and send the output data to the user output portion. The operational circuitry can be housed in, for example, the first arm 12 or the second arm 28, depending on the particular embodiment.

Referring to FIGS. 1 and 3, in certain embodiments, the electronic display 40 is further configured to display the doneness of the meat. In some embodiments, the user output portion includes a speaker element 60 electrically connected to the operational circuitry to audibly indicate the doneness of the meat. In such embodiments, the sound may travel from the speaker element 60 through speaker holes 64 in the second arm 28.

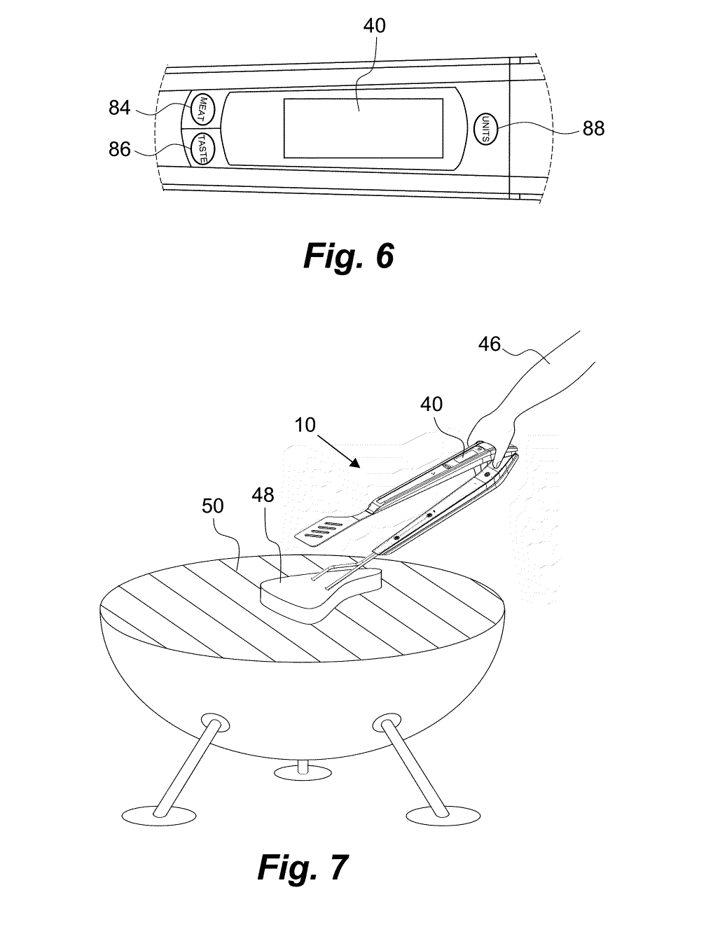

Referring to FIGS. 3 and 5, particular embodiments further comprise a user input portion electrically connected to the operational circuitry 44. The user input portion may include, for example, buttons 80, along with button faces printed onto an interface panel 66. Referring to FIG. 6, in embodiments, the user input portion is configured to allow the user to readily choose a meat setting from a plurality of meat options, for example, by pressing the MEAT button face 84. In such embodiments, the meat options include one or more of beef, veal, lamb, pork, chicken, turkey, as well as any other suitable cooking meat. The meat setting is typically displayed on the electronic display 40 when the cooking tongs 10 are powered on.

In typical embodiments, the user input portion is configured to allow the user to readily choose a doneness setting from a plurality of doneness options, for example, by pressing the TASTE button face 86. In such embodiments, it is typical for at least one or two of the doneness options to be selected from the group consisting of rare, medium rare, medium and well done. In additional embodiments, the user input portion is configured to allow the user to readily choose between temperature units of Celsius and Fahrenheit, for example, by pressing the UNIT button face 88, such that the temperature of the meat is displayed in the chosen temperature units while the cooking tongs 10 are powered on. The doneness setting and doneness options are also typically displayed on the electronic display 40 when the cooking tongs 10 are powered on.

In embodiments, the first inner portion 14 and the second inner portion 30 may be comprised of stainless steel. In particular embodiments, the first outer portion 16 and the second outer portion 32 are comprised of a polymer which may be heat and impact-resistant. In general, the fork 22, tines 24, and spatula 38 can be made of any suitable food-safe material capable of withstanding the temperatures of a barbecue, such as stainless steel or a high temperature polymer.

Referring to FIG. 3, in certain embodiments, the fork 22 comprises two tines 24, generally parallel to each other and laterally spaced apart. Further, the spatula 38 may be a solid piece or may include one or more apertures 56 in the surface. Moreover, the spatula 38 may have a first edge 74 and a second edge 76, each such edge having differing types and degrees of serration.

Referring again to FIG. 5 for illustration, the operational circuitry, electronic display 40, and temperature sensor 26 may be powered by a battery source located in, for example, battery compartment 82. The battery source may be, for example, one or more common alkaline batteries or lithium-ion batteries, typically housed within the first arm 12 between battery contacts 70 and 72 (see, for example, FIG. 3). As depicted in FIG. 2, access to the battery compartment 82 is generally conveniently provided by way of a battery door 62 in the first arm 12.

During operation of the cooking tongs 10, the temperature sensing function is generally activated by the user selecting the desired meat setting and desired doneness setting by way of the user input portion while visually referring to the electronic display 40. As a result of these selections, appropriate values are programmed into or used by the operational circuitry 44. The user then inserts the one or more tines 24 including a temperature sensor 26 into the meat to be measured. After a short period of time, the temperature of the meat will be displayed on the electronic display 40. Additionally, a sound, such as a beep, may be played through the speaker element 60 when the measured temperature is within the range of the temperatures corresponding to the selected doneness and meat settings. Conversely, a sound may be played to alert the user that the temperature is above or below the desired doneness level. Portions of the electronic display 40 may also flash or change color to indicate the level of doneness.

FIG. 7 illustrates one of the most ergonomically advantageous aspects of the invention. The cooking tongs 10 are shown positioned with the second arm 28 disposed above the first arm 12, such that when the tines 24 of the fork 22 are inserted into the food item 48, the electronic display 40 is facing up towards the user 46 for easy viewing. In contrast, U.S. D447,430 (“Kehoe”), appears to teach meat thermometer tongs in which the display is located on the same arm as the fork tines. Such an arrangement would make it difficult or nearly impossible to view the display while the tines are inserted into the food item. By way of example, if the tines are inserted at an oblique angle with the display facing upward, in similar fashion to the embodiment of the present invention as illustrated in FIG. 7, then the spatula portion of the Kehoe tongs would likely be contacting the cooking surface 50, making it difficult to achieve any significant depth of penetration into the meat with the tines. If the Kehoe tongs were held obliquely with the display facing down, then inserting the tines would be easier, but the display would not be easily viewable to the user. If the Kehoe tongs were held vertically then the display would be difficult to read without leaning backwards or to the side in order to see the display, since the grill/cooking surface is often much lower than eye level. Also, if held in the vertical direction the spatula portion of the Kehoe tongs may again interfere with the insertion of the tines unless the user inserts them into the edge of the meat, which is not desirable since the center of the meat may be at a cooler temperature than the edges. Embodiments of the present invention, however, enable the user to insert the tines 24 at an oblique angle with the electronic display 40 facing upward for easy reading. The user 46 is therefore able stand in a normal cooking position while reading the electronic display 40, without contorting his or her body.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. Cooking tongs comprising:
(a) a first arm having a first inner portion, a first outer portion, a first proximal end and a first distal end, the first arm further having a fork at the first distal end, the fork having at least one tine, the at least one tine having a temperature sensor therein;
(b) a second arm having a second inner portion, a second outer portion, a second proximal end and a second distal end, the second arm being in hinged association with the first arm at generally the second proximal end and the first proximal end, the second arm further having a spatula at the second distal end;
(c) a user output portion configured to provide status information to the user, the status information including a temperature of a meat and a doneness of the meat, the user output portion including an electronic display configured to display at least the temperature of the meat, the electronic display being disposed on the second outer portion at a distance from the second distal end, thereby allowing the electronic display to be readily viewable to a user while the fork is at least partially inserted in a food item on a cooking surface with the second arm generally disposed above the first arm; and
(d) operational circuitry configured to receive input data from the temperature sensor, generate output data associated with the status information; and send the output data to the user output portion.

2. Cooking tongs as defined in claim 1 in which the electronic display is further configured to display the doneness of the meat.

3. Cooking tongs as defined in claim 1 in which the user output portion further includes a speaker element, the speaker element being electrically connected to the operational circuitry to audibly indicate the doneness of the meat.

4. Cooking tongs as defined in claim 1 further comprising a user input portion electrically connected to the operational circuitry, the user input portion being configured to allow the user to readily choose a meat setting from a plurality of meat options.

5. Cooking tongs as defined in claim 4 in which at least one of the meat options is selected from the group consisting of beef, veal, lamb, pork, chicken and turkey.

6. Cooking tongs as defined in claim 1 further comprising a user input portion electrically connected to the operational circuitry, the user input portion being configured to allow the user to readily choose a doneness setting from a plurality of doneness options.

7. Cooking tongs as defined in claim 6 in which at least one of the doneness options is selected from the group consisting of rare, medium rare, medium and well done.

8. Cooking tongs as defined in claim 1 further comprising a user input portion electrically connected to the operational circuitry, the user input portion being configured to allow the user to readily choose between temperature units of Celsius and Fahrenheit such that the temperature of the meat is displayed in the chosen temperature units while the cooking tongs are powered on.

9. Cooking tongs as defined in claim 1 further comprising a first heat-resistant grip disposed on the first outer portion and a second heat-resistant grip disposed on the second outer portion.

10. Cooking tongs as defined in claim 1 in which the first inner portion and the second inner portion are comprised of stainless steel.

11. Cooking tongs as defined in claim 1 in which the fork and the spatula are comprised of stainless steel.

12. Cooking tongs as defined in claim 1 in which the first outer portion and the second outer portion are comprised of a polymer.

13. Cooking tongs as defined in claim 1 in which the fork comprises two tines, the two tines being generally parallel and laterally spaced apart.

14. Cooking tongs as defined in claim 1 in which the distance is at least 2 inches.

15. Cooking tongs as defined in claim 1 in which the hinged association is provided by way of a hinge clip, the hinge clip elastically clamping the first inner portion to the second inner portion.

16. Cooking tongs comprising:
(a) a first arm having a first inner portion, a first outer portion, a first proximal end and a first distal end, the first arm further having a fork at the first distal end, the fork having at least one tine, the at least one tine having a temperature sensor therein;
(b) a second arm having a second inner portion, a second outer portion, a second proximal end and a second distal end, the second arm being in hinged association with the first arm at generally the second proximal end and the first proximal end, the second arm further having a spatula at the second distal end;
(c) a user output portion configured to provide status information to the user, the status information including a temperature of a meat and a doneness of the meat, the user output portion including an electronic display configured to display the temperature of the meat and the doneness of the meat, the electronic display being disposed on the second outer portion at a distance from the second distal end, thereby allowing the electronic display to be readily viewable to a user while the fork is at least partially inserted in a food item on a cooking surface with the second arm generally disposed above the first arm;
(d) operational circuitry configured to receive input data from the temperature sensor, generate output data associated with the status information; and send the output data to the user output portion; and
(e) a user input portion electrically connected to the operational circuitry, the user input portion being configured to allow the user to readily choose:
(i) a meat setting from a plurality of meat options;
(ii) a doneness setting from a plurality of doneness options; and
(iii) between temperature units of Celsius and Fahrenheit such that the temperature of the meat is displayed in the chosen temperature units while the cooking tongs are powered on.

17. Cooking tongs as defined in claim 16 in which:
(a) at least two of the meat options are selected from the group consisting of beef, veal, lamb, pork, chicken and turkey; and
(b) at least two of the doneness options are selected from the group consisting of rare, medium rare, medium and well done.

18. Cooking tongs as defined in claim 16 in which the user output portion further includes a speaker element, the speaker element being electrically connected to the operational circuitry to audibly indicate the doneness of the meat.

19. Cooking tongs as defined in claim 16 in which:
(a) the first inner portion, the second inner portion, the fork and the spatula are comprised of stainless steel; and
(b) the first outer portion and the second outer portion are comprised of a polymer.

20. Cooking tongs comprising:
(a) a first arm having a first inner portion, a first outer portion, a first proximal end and a first distal end, the first arm further having a fork at the first distal end, the fork having at least one tine, the at least one tine having a temperature sensor therein;
(b) a second arm having a second inner portion, a second outer portion, a second proximal end and a second distal end, the second arm being in hinged association with the first arm at generally the second proximal end and the first proximal end, the second arm further having a spatula at the second distal end;
(c) a user output portion configured to provide status information to the user, the status information including a temperature of a meat and a doneness of the meat, the user output portion including:
(i) an electronic display configured to display the temperature of the meat and the doneness of the meat, the electronic display being disposed on the second outer portion at a distance from the second distal end, thereby allowing the electronic display to be readily viewable to a user while the fork is at least partially inserted in a food item on a cooking surface with the second arm generally disposed above the first arm; and
(ii) a speaker element being electrically connected to the operational circuitry to audibly indicate the doneness of the meat;
(d) operational circuitry configured to receive input data from the temperature sensor, generate output data associated with the status information; and send the output data to the user output portion; and
(e) a user input portion electrically connected to the operational circuitry, the user input portion being configured to allow the user to readily choose:
(i) a meat setting from a plurality of meat options, at least two of the meat options being selected from the group consisting of beef, veal, lamb, pork, chicken and turkey; and
(ii) a doneness setting from a plurality of doneness options, at least two of the doneness options being selected from the group consisting of rare, medium rare, medium and well done; and
(iii) between temperature units of Celsius and Fahrenheit such that the temperature of the meat is displayed in the chosen temperature units while the cooking tongs are powered on.
